(19) United States
(12) Patent Application Publication
(10) Pub. No.: US 2008/0218332 A1
(43) Pub. Date: Sep. 11, 2008

(54) PORTABLE BATHER MONITORING DEVICE AND A WATERSIDE MONITORING SYSTEM

(75) Inventor: Michael Lyons, Berkshire (GB)

Correspondence Address: KNOBBE MARTENS OLSON & BEAR LLP, 2040 MAIN STREET, FOURTEENTH FLOOR, IRVINE, CA, 92614, US

(73) Assignee: SenTAG Limited, Berkshire (GB)

(21) Appl. No.: 12/024,971

(22) Filed: Feb. 1, 2008

Related U.S. Application Data
(63) Continuation of application No. PCT/GB2006/002875, filed on Aug. 2, 2006.

(30) Foreign Application Priority Data
Aug. 3, 2005 (GB) 0516000.7

(51) Int. Cl. G08B 21/02; G08B 21/08

(52) U.S. Cl. 340/529; 340/539.11; 340/573.1

(57) ABSTRACT

A portable bather monitoring device, for example in the form of a wristband device, incorporates a pre-alarm to emit a warning signal to a bather to forewarn him that he is operating outside a defined rule-set in such a way than an alarm will be generated in a predetermined time unless he modifies his behavior or actively operates a delay to the alarm. The pre-alarm is notified to the bather by audible, vibration or other means and an override input is provided which in defined circumstances allows the bather to delay generation of the alarm used to alert waterside staff to the fact that a bather is in danger and requires immediate assistance.

### CROSS-REFERENCE TO RELATED APPLICATIONS

This application claims the benefit of PCT Application PCT/GB2006/002875, entitled A Portable Bather Monitoring Device and a Waterside Monitoring System, which is hereby incorporated by reference.

### BACKGROUND OF THE INVENTION

1. Field of the Invention

The present invention relates to a portable bather monitoring device and a waterside monitoring system. In particular, the invention relates to individual monitoring devices worn by each of a plurality of bathers in a swimming pool or other bathing area, each portable bather monitoring device outputting an alert signal to cause an associated alarm system to raise an alarm in the event that the bather is determined to be in danger and in need of lifesaving assistance.

2. Description of the Related Technology

Large public swimming pools are generally monitored by life guards to assist any swimmers that get into trouble in the water. However, this is not universal. In addition, the rise in the number of fitness gyms has seen a large proliferation in the number of pools and hotels and other leisure complexes providing swimming facilities. In these, typically smaller, pools there is less likelihood of continuous waterside supervision. Whilst some minimal supervision of these types of pools may be provided, for example by video link to the hotel reception desk or occasional poolside supervision, there is still an increased risk to the bather. Furthermore, it is widely accepted that waterside supervisors can and do miss bathers getting into difficulties in any size of facility.

U.S. Pat. No. 5,907,281 describes a swimmer location monitor for locating swimmers who could be in danger of drowning. Each swimmer wears a swimmer location monitor which is a miniature electronic device which determines the extent of the swimmer's danger and emits an electromagnetic alarm signal whenever such a danger exists. The alarm may be audible and/or visual and is sounded on the surface while the swimmer's location is tracked in real time from the signals received on an antenna network deployed along the bottom of the swimming area. The signals are combined in a central processor and the computed real-time location is displayed graphically on a monitor to guide the guard personnel in rescue operations. A problem with the type of system taught by U.S. Pat. No. 5,907,281 is the cost of retrofitting existing swimming pools with, and incorporating into new-build pools, the equipment to detect and track the signals for locating swimmers. A further problem is that it is difficult to set-up the system to eliminate unnecessary, or false, alarms without raising the alarm threshold above a level where real bather difficulty goes unreported or is reported later in the event.

U.S. Pat. No. 6,154,140 describes an intelligent personal underwater monitoring device which recognizes when a swimmer is in trouble and transmits a warning signal. The system comprises a device worn by the swimmer which senses water pressure and transmits a first signal when a predetermined depth is passed by the swimmer. A processor determines whether the first signal deviates form a normal signal and generates an output signal representative of whether the swimmer behavior is normal or not. An alarm signal is generated if the output signal indicates that the swimmer behavior is not normal. The first signal is an acoustic, sinusoidal pulse signal, a parameter of which (for example pulse duration) is varied dependent on the depth of the swimmer. The first signal is emitted for the duration of time that the swimmer is in the water and therefore requires substantial battery power. A problem with this system is that it is individual swimmer's may behave in a “non-normal” way resulting in false alarms when the swimmer is control and perfectly safe.

### SUMMARY OF CERTAIN INVENTIVE ASPECTS

We have appreciated that an improvement over existing swimmer monitoring devices may be achieved if the device incorporates a pre-alarm to forewarn the swimmer that they are operating outside a defined rule-set in such a way that an alarm will be generated unless they modify their behaviour in some way or actively operate a delay to the alarm. The provision of a pre-alarm allows the swimmer to prevent an alarm being signalled when the swimmer determines that he is not in danger, thus reducing the overall level of false alarms noted by any monitoring system and life guards. The number of false positive alarms may be reduced whilst still maintaining the lowest practical thresholds in terms of the bather's safety.

The invention is defined in the claims to which reference is now directed.

### BRIEF DESCRIPTION OF THE DRAWINGS

FIG. 1 shows schematically a wristband accommodating a swimmer-worn portable monitoring device in accordance with one embodiment of the invention;

FIG. 2 shows schematically the functional blocks of a portable monitoring device in accordance with an embodiment of the invention; w

FIG. 3 is a flowchart showing the basic processing steps performed by a processor;

FIG. 4 shows schematically a waterside monitoring system and a plurality of bathers with portable monitoring devices in accordance with an embodiment of the invention.

### DETAILED DESCRIPTION OF CERTAIN INVENTIVE EMBODIMENTS

The embodiment of the invention is a swimmer-worn portable monitoring device and a waterside monitoring system in which a plurality of swimmers each wear a portable monitoring device. The portable bather monitoring device may be used to monitor bather well-being in a swimming pool or other suitably equipped body of water and environs and is preferably issued to the bather upon entering the protected environment and deactivated upon surrender when the bather leaves the protected environment. By protected environment, we mean a designated area in which one or more people are responsible for providing lifesaving cover to bathers who find themselves in difficulties.

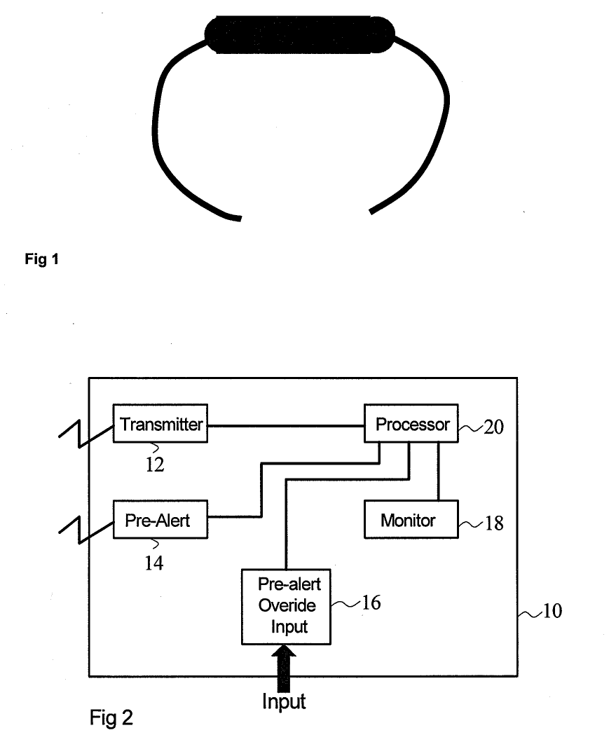

The portable bather monitoring device 10 is preferably accommodated in a wrist-band as depicted schematically in FIG. 1. As shown schematically in FIG. 2, the device 10 comprises a transmitter 12, a pre-alarm 14, a pre-alarm override input 16, a monitor 18 and a processor 20 coupled to each of the transmitter 12, pre-alarm 14, pre-alarm override input 16 and monitor 18. The device 10 requires a portable power supply (not shown in FIG. 2) such as a Toshiba CR 2016 coin cell capable of powering the transmitter 12, pre-alarm 14, monitor 18 and processor 20.

The transmitter 12 is an ultrasonic resonator, for example a piezo-electric resonator e.g. a cylindrical piezo-electric resonator produced by the Ferroperm company part number 26111 or 26112, operating in the frequency range 20 KHz to 300 KHz and most preferably between 20 KHz and 100KHz and hence suitable for transmitting an ultrasonic vibration through water to a receiver of an associated waterside monitoring system.

The purpose of the pre-alarm 14 is to emit a warning signal to warn the bather that the device is going to cause an alarm imminently via wireless transmission of an alert transmission. The pre-alarm 14 may therefore comprise vibration means, visual indication means such as one or more light emitting diodes, alarm means audible to the bather (but not necessarily audible to the wider environment) or any combination of these. When a piezo-electric resonator is used as the transmitter 12, appropriate choice of resonator may enable the transmitter 12 to be made to vibrate at an amplitude and frequency which may be felt by the device wearer by driving the transmitter at a different frequency to that of ultrasonic transmission hence allowing the transmitter 12 to be operated as the pre-alarm 14 which would not then be a separate component of the device 10. It is also possible to choose a piezo-electric resonator which may be driven to provide both audible and ultrasonic frequencies.

The pre-alarm override input 16 is simply a means for allowing the bather to confirm that all is well and he is not in any imminent danger and hence to signal that a system alarm is not necessary at that time. The pre-alarm therefore provides a manual override to the alarm. In the presently preferred embodiment it is provided by a simple mechanical switch which may be operated by the bather.

Alternatives techniques may require some other bather direct intervention, for example shaking for a given period of time or covering a light sensing device for a given period of time. The override, if used in potentially hazardous circumstances, for example at the bottom of a pool, cannot be repeated without limit. This functionality may be controlled by implementation of an appropriate rule-set in the processor. A predetermined maximum, which may be zero or one, may be set for the permissible number of times that the pre-alarm override input may be used to delay an alarm.

The monitor 18 detects the bather situation which may be based for example on one or more of the following: whether or not the bather is in water, the depth of the bather, the duration for which the bather has been between first and second depth thresholds, any bather motion, bather heartbeat, etc. . . . The monitor 18 may, therefore, be one or more individual sensing units and is to be understood as the sensor, or group of sensors, monitoring the bather's environment and/or behaviour and/or physical state which alone or in combination comprise the bather situation. In the simplest embodiment envisaged, the monitor 18 comprises depth sensing means, such as a pressure sensor.

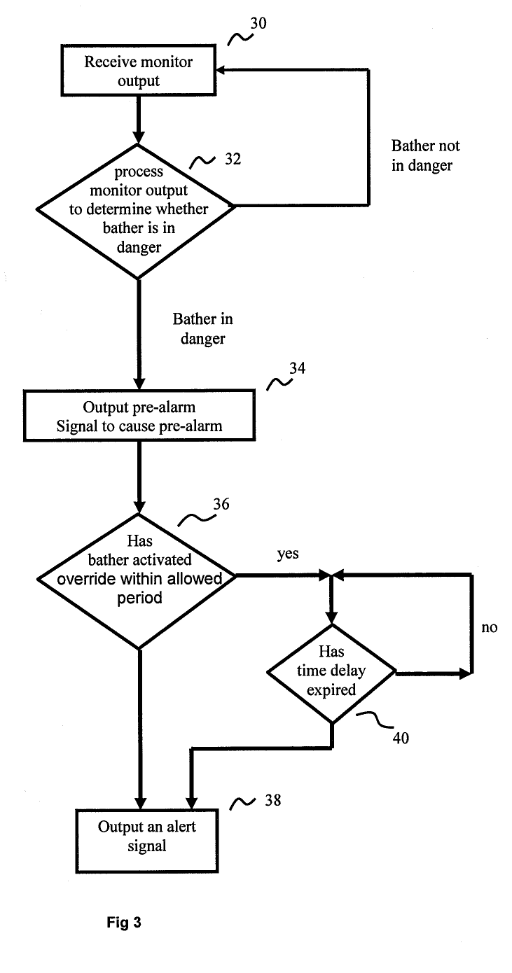

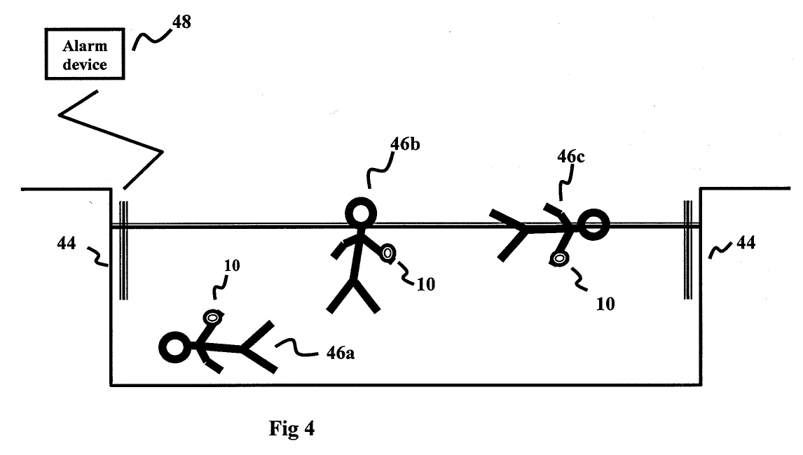

The processor 20 accepts inputs from the monitor 18 and the pre-alarm override input 16. The processor operates to determine the well-being or otherwise of the bather and generate an alarm when the bather is determined to be in danger. The basic processing steps are shown in the flow-chart of FIG. 3. The processor 20 receives one or more inputs 30 outputted by the monitor 18. The processor processes the inputs to determine whether the bather is in danger 32. The processor may make the determination by comparison with look-up tables, by calculation or any other way. In the presently preferred embodiment, this processing comprises comparing the monitor input or inputs to a rule-set stored in memory of the device 10 to determine whether or not the bather is deemed to be in danger. For example, the rule-set may compare the monitored bather depth and length of time at the depth against look-up table values to determine whether or not a safety threshold has been reached. If the safety threshold has been reached, a determination is made by the processor that the bather is in danger which in turn causes the processor to output a pre-alarm signal causing the pre-alarm to emit a warning signal. The rule-set may include bather motion and may be tailored to a bather skill level set when the device 10 was issued to the bather. Other variations and/or sophistications of the rule-set may be implemented and will be obvious to those skilled in the art.

If the bather is determined to be safe, that is no imminent danger to the bather is detected by the processor, the processor awaits further monitor outputs and recommences processing. If the bather is determined to be in danger, the processor outputs a pre-alarm signal 34. The pre-alarm signal causes the pre-alarm to emit a warning to the bather, the warning signalling to the bather than the device will imminently output an alert signal which when detected by a waterside monitoring system will cause an alarm to be generated to alert waterside staff to the fact that a bather is in danger and requires immediate assistance. Thus the pre-alarm gives the bather an opportunity to establish that he is in fact safe and as a result to obtain additional time before the alarm is sounded. Once the pre-alarm signal has been outputted, the bather has a predetermined period, for example 5 seconds, to activate the pre-alarm override input if he wishes. The processor receives any input from the pre-alarm override input and determines whether the bather has activated the pre-alarm override input within the allowed time 34. If the bather does not activate the pre-alarm override input within the allowed time then the processor outputs an alert signal 38 causing the transmitter to transmit an alert transmission. The alert transmission is received by the waterside monitoring system and causes an alarm device in the vicinity of the water to generate an alarm to notify waterside safety staff, for example life guards, that a bather is in danger and requires immediate assistance. If the bather activates the pre-alarm override input within the allowed time the processor delays the output of the alert signal, for example by testing whether or not a time delay has expired and only moving to step 38 when the delay has expired. The time delay implemented by activation of the pre-alarm may be a fixed period, say 30 seconds, after which the alarm is triggered if the bather has not returned to a position determined by the processor to be safe or the processor may be configured to allow multiple applications of time delays up to a maximum, for example up to 3 delays, the delays reducing from say 30 seconds to say 10 seconds, followed by triggering of the alarm regardless of whether or not the pre-alarm is reactivated by the bather. The time delay implemented by the processor may be dependent on the bather's situation, for example the depth and/or motion of the bather, or on parameters set by the system provider when the portable bather monitoring device is issued, such as bather age, skill level or determined by the level of staffing or number of bathers. The processor continuously or at frequent intervals receives inputs from the monitor and the alarm may only be triggered if the bather is determined to be in danger. Once the pre-alarm has gone off, the bather therefore has the choice of activating the pre-alarm override input to allow him to remain in his relative position or activity whilst delaying an alarm or may simply choose to return to the surface or a safe situation within the allowed time to prevent an alarm.

In addition, the pre-alarm override input can be used to cancel any active alert signal. This cancellation would, however, only be permitted in a situation that is determined by the rule-set of the processor to be deemed safe, for example where a depth/time related alert is actively cancelled by the wearer in a situation in which the device is determined to be above the water's surface. This feature may reduce the time devoted by waterside staff to investigation of false positive alerts and alarms.

The portable bather monitoring device 10 is for use in a waterside monitoring system as shown schematically for swimming pool 42 in FIG. 5. One or more receivers 44, in this case two, are located at least partially submerged in the water. The receivers 44 detect any ultrasonic alert transmissions emitted by any one of the portable bather monitoring devices 10 issued to, and worn by, bathers 46a-c. The receivers 44 may be an integral part of the pool wall, attached to the pool wall or simply disposed within the water and may be battery powered or mains powered. The receivers 44 may be fully or only partially submerged. The number and placement of receivers 44 depends on the size and shape of the body of water. Each receiver 44 is coupled to an alarm device 48. The receivers may be physically connected by a wire or the like or may transmit a signal, for example an RF signal, to the alarm device receiver. In the presently preferred embodiment, each receiver is a based on a hydrophone with sensitivity in the relevant frequency ranges such as those produced by SRD Limited, part numbers HS/70, HS/150 or HS/300 as detailed at www.srduk.com and detects the ultrasonic alert transmissions emitted by the portable bather monitoring device 10 of a bather determined to be in danger, for example bather 46a who may have been swimming underwater for a prolonged period deemed in accordance with the rule-set to indicate a danger to the bather 46a. Upon detection of the ultrasonic alert transmission, the receiver relays the alert transmission to an alarm device 48 by transmitting an RF signal which is received by the alarm device causing the desired alarm. In the presently preferred embodiment the alarm takes the form of an audible alarm signal emitted by a loudspeaker of the alarm device 48. The alarm may sound for a preset time or may sound indefinitely until switched off by authorised lifesaving staff.

The portable bather monitoring device may be equipped to transmit both an ultrasonic vibration alert signal and an RF electromagnetic alert signal. Although the transmission of RF in water is very restrictive, for bathers at or near the surface an RF alert signal may be capable of detection if the frequency is chosen with care and the water conditions are suitable. Alternatively, for some applications, it may be preferable to equip the portable bather monitoring device with just an RF transmitter. Means for determining whether the bather is in or out of the water may be provided by the portable bather monitoring device. For example, capacitance type water detectors or pressure sensing means may be used for this purpose. When pressure sensing means are used to monitor the depth of the bather, re-calibrate of the pressure sensing means may be provided. For example, the portable bather monitoring device may be set-up to recalibrate the pressure sensor each time it is issued so that atmospheric pressure changes are accommodated. There are a number of sophistications and enhancements to those outlined above that would be apparent to a skilled man working in this field. Alternatively, the recalibration may only be initiated by authorised personnel at intervals determined suitable by the personnel. Recalibration may be particularly relevant if the portable bather monitoring devices are transferred from one protected environment to a different protected environment at a markedly different altitude.

Although a wristband type of portable bather monitoring device has been described as presently preferred, the device may be worn by the bather in any suitable fashion, for example as a pendant, or incorporated in swimming gear such as goggles, hat, or swimsuit.

Alert transmissions may be customised by the portable bather monitoring device or a single alert transmission used by all devices. Customisation may include incorporating an identification signal uniquely identifying the portable bather monitoring device so that the information identifying the individual to whom the device was issued could be made available upon alarm. Other types of customisation of the alert transmission may allow the transmission to provide information about the bather's situation, for example the depth of the bather in danger. Simple triangulation of alert signals using a number of receivers could give additional location information. The portable bather monitoring devices may be activated upon issue and deactivated once the bather has returned the device to extend life of the power source or may have a set lifespan or a rechargeable power source. Issue means may be provided to authorised personnel to allow them to customise the set-up of a portable bather monitoring device as it is issued to a bather. The type of customisation may include setting any of bather ability, age, or even weather conditions. The setting of such variables may be used by the processor to adapt the time delay applied between pre-alarm and alarm.

Wirelessly transmitted alerts could also be cancelled via the pre-alarm override input. For example, if the portable bather monitoring device is determined to be out of water all further assessment of the bather's situation could be suspended until re-entry to water is detected.

With respect to the above description, it is to be realised that equivalent apparatus and methods are deemed readily apparent to one skilled in the art, and all equivalent apparatus and methods to those illustrated in the drawings and described in the specification are intended to be encompassed by the present invention. Therefore, the foregoing is considered as illustrative only of the principles of the invention. Further since numerous modifications and changes will readily occur to those skilled in the art, it is not desired to limit the invention to the exact construction and operation shown and described, and accordingly, all suitable modifications and equivalents may be resorted to, falling within the scope of the invention.

1. A portable bather monitoring device worn by a bather in a protected bathing environment, the device comprising:
(a) a transmitter for transmitting an alert transmission;
(b) a pre-alarm for emitting a warning signal to a bather that an alert transmission is impending;
(c) a pre-alarm override input for allowing the bather to delay an impending alert transmission;
(d) a monitor for monitoring the bather's situation, and
(e) a processor, coupled to the transmitter, pre-alarm, pre-alarm override input and monitor, configured:
(i) to process the input from the monitor to determine whether the bather is in danger;
(ii) to output a pre-alarm signal causing the pre-alarm to emit a warning signal to the bather if the bather is determined to be in danger;
(iii) to detect whether a pre-alarm override is inputted in a predetermined period following the output of the pre-alarm warning signal and to delay the output of an alert signal if a pre-alarm override is detected; and
(iv) to output an alert signal to cause the transmitter to transmit an alert transmission when the bather is determined to be in danger, and the predetermined period and any delay has expired.

2. A portable bather monitoring device according to claim 1, wherein the transmitter operates at an ultrasonic frequency.

3. A portable bather monitoring device according to claim 1, wherein the transmitter operates at a radio frequency.

4. A portable bather monitoring device according to claim 1, comprising both an ultrasonic frequency transmitter and a radio frequency transmitter.

5. A portable bather monitoring device according to claim 1, further comprising means for determining whether the bather is in or out of water, and wherein the processor is configured to delay the alert signal indefinitely if the bather is out of water and to reset the monitoring process when the bather next enters water.

6. A portable bather monitoring device according to claim 1, wherein the monitor comprises depth sensing means and wherein the processor is configured to calculate the delay to be applied to the alert signal dependent on the depth of the bather.

7. A portable bather monitoring device according to claim 6, wherein the depth sensing means are pressure sensing means and wherein the device further comprises calibration means for re-calibrating the pressure sensing means at intervals to adapt to changes in atmospheric pressure.

8. A portable bather monitoring device according to claim 7, further comprising motion sensing means coupled to the processor, and wherein the processor is further configured to calculate the delay dependent on the detected motion of the bather.

9. A portable bather monitoring device according to claim 1, wherein the processor is further configured to calculate the delay dependent on the ability of the bather preset into the portable bather monitoring device upon issue to the bather.

10. A portable bather monitoring device wherein the processor is further configured to calculate the delay dependent on two or more of the factors of claim 9.

11. A portable bather monitoring device according to claim 1, wherein the device is provided on a wristband.

12. A portable bather monitoring device according to claim 1, wherein the pre-alarm comprises vibration means and the processor is configured to output a signal to the vibration means to cause vibration of the device as the pre-alarm warning.

13. A portable bather monitoring device according to claim 1, wherein the pre-alarm comprises visual indication means and the processor is configured to output a signal to the visual indication means to cause visual pre-alarm warning.

14. A portable bather monitoring device according to claim 1, wherein the pre-alarm comprises means for creating a bather audible pre-alarm and the processor is configured to output a signal to the means to cause a bather audible pre-alarm.

15. A portable bather monitoring device according to claim 1, wherein the pre-alarm comprises means for providing at least two of vibration means, visual indication means and bather audible pre-alarm.

16. A portable bather monitoring device according to claim 1, wherein the pre-alarm override input is a mechanical switch and its activation requires switching for a predetermined activation time.

17. A portable bather monitoring device according to claim 1, wherein the transmitter customises the alert transmission by incorporating an identification signal uniquely identifying the portable bather monitoring device.

18. A portable bather monitoring device according to claim 1, wherein the transmitter customises the alert transmission by incorporating basic bather depth information.

19. A portable bather monitoring device according to claim 1, wherein the processor is configured to use the pre-alarm override input to cancel or suppress transmitted alerts.

20. A portable bather monitoring device according to claim 19, wherein the processor is configured to use the cancellation or suppression of transmitted alerts to cause the suspension of monitoring until the bather re-enters the water.

21. A portable bather monitoring device according to claim 1, wherein the processor is configured to delay monitoring of the bather situation until entry into water by the bather is detected.

22. A waterside monitoring system for monitoring the well-being of a plurality of bathers, the system comprising an alarm device disposed in the vicinity of the water, a receiver disposed in the water and coupled to the alarm device, and a plurality of portable bather monitoring devices according to any of claim 1, wherein the receiver is configured to detect an alert transmission and to relay the alert transmission to the alarm device to activate an alarm.

23. A waterside monitoring system according to claim 22, further comprising issue means for activating a personal bather monitoring device upon issue to a bather and deactivating a personal bather monitoring device upon its return.

24. A waterside monitoring system according to claim 22, wherein the issue means is configured to set a bather ability level in the processor of the personal bather monitoring device when the personal bather monitoring device is activated.
